(19) United States
(12) Patent Application Publication
(10) Pub. No.: US 2017/0171445 A1
(43) Pub. Date: Jun. 15, 2017

(54) BRIGHTNESS COMPENSATION METHOD AND ELECTRONIC DEVICE FOR FRONT-FACING CAMERA, AND MOBILE TERMINAL

(71) Applicants: Le Holdings (Beijing) Co., Ltd., Beijing (CN); Lemobile Information Technology (Beijing) Co., Ltd., Beijing (CN)

(72) Inventor: Zhenyu Wang, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/244,951

(22) Filed: Aug. 23, 2016

Related U.S. Application Data
(63) Continuation of application No. PCT/CN2016/088336, filed on Jul. 4, 2016.

(30) Foreign Application Priority Data
Dec. 10, 2015 (CN) 201510918322.9

(51) Int. Cl. H04N 5/235

(52) U.S. Cl. CPC H04N 5/2351; H04N 5/2354; H04N 5/23293

(57) ABSTRACT

Disclosed are a brightness compensation method and an electronic device for a front camera, and a mobile terminal. The method includes: firstly, acquiring a current ambient brightness; then judging whether or not the brightness is less than a light compensation starting threshold, and if so, calculating a compensation brightness; and judging whether or not the compensation brightness is less than a brightness compensation extreme value of a screen, and if so, turning on the screen and adjusting the brightness of the screen to the compensation brightness. In the solution, the screen or a front flash is individually used for compensation at first, and when the requirement of brightness compensation is not satisfied, the screen and the front flash can be used together so as to satisfy the compensation requirement, so that the current brightness can be maximally compensated, thereby achieving a better shooting effect under adverse shooting conditions.

### CROSS REFERENCE TO RELATED APPLICATIONS

This application is a continuation of International Application No. PCT/CN2016/088336, filed on Jul. 4, 2016, which is based upon and claims priority to Chinese Patent Application No. 201510918322.9, filed on Dec. 10, 2015, titled “Brightness Compensation Method for Front camera, and Mobile Terminal”, the entire contents of which are incorporated herein by reference.

### TECHNICAL FIELD

The application relates to the field of photo shooting of mobile terminal devices, and particularly relates to a brightness compensation method and an electronic device for a front camera, and a mobile terminal.

### BACKGROUND

With the development of technologies, electronic products become more and more popular and also have more and more functions. An intelligent mobile phone has already become one of essential electronic products. The mobile phone has more and more functions and has already replaced many other consumer electronic products. For example, the mobile phone can replace a camera and a video recorder for photo shooting and video recording. As the performance of the mobile phone is higher and higher, there are more and more available application programs in the mobile phone and the mobile phone also has many functions of a computer, such as image processing, etc. In order to obtain a better shooting effect, flashes are required to be used to help a camera to shoot under the condition of dim light.

At present, some mobile phones are provided with flashes at rear-facing cameras for use during shooting of the rear-facing cameras. In order to ensure the shooting effect of the front camera, Chinese patent document CN202856820U discloses a mobile phone having a front flash. The mobile phone includes a face shell, a bottom shell and a battery cover; a mainboard module is fixedly installed between the face shell and the bottom shell; a front camera and a front flash are arranged on one side, which faces the face shell, of the mainboard module; the front camera is welded to the mainboard module through FPC; the front flash is welded to the mainboard module through SMT; a rear-facing camera and a rear-facing flash are arranged on one side, which faces the bottom shell, of the mainboard module; and the rear-facing camera is fixed to the mainboard module through an FPC connector. The mobile phone in the solution has the front camera and the rear-facing camera, and the front flash can be turned on during the processes of taking a selfie, making a video call, etc., so as to ensure the shooting effect. However, because a user is close to the mobile phone during the processes of taking a selfie, making a video call, etc., excessive brightness of the front camera will cause injuries to the eyes of the user, while insufficient brightness cannot bring an expected shooting effect. In addition, because the ambient brightness that the user uses the mobile phone is different and required compensation brightness is different, the flash with fixed brightness cannot satisfy the requirement.

### SUMMARY

Therefore, the application discloses a brightness compensation method and an electronic device for a front camera, and a mobile terminal, so as to enable a front flash of a mobile phone to satisfy the requirements under user's environment change.

One objective of the embodiments of the application is to provide a brightness compensation method for a front camera, including the following steps: acquiring a current ambient brightness; judging whether or not the brightness is less than a light compensation starting threshold, and if so, calculating a compensation brightness; and judging whether or not the compensation brightness is less than a brightness compensation extreme value of a screen, and if the compensation brightness is less than a brightness compensation extreme value of a screen, turning on the screen and adjusting the brightness of the screen to the compensation brightness.

Another objective of the embodiments of the application is to provide a mobile terminal having a front camera brightness compensation function, including a face shell and a rear shell which are in snap-fit arrangement, wherein a terminal controller is arranged in a cavity formed by the face shell and the rear shell, and a screen and a front camera are arranged on the face shell; and at least one front flash is also arranged on the face shell, the brightness of the front flash can be adjusted, and the terminal controller is used for controlling the brightness of the front flash and the brightness of the screen.

Another objective of the embodiments of the application is to provide an electronic device, including: at least one processor; a memory communicably connected with the at least one processor for storing instructions executable by the at least one processor, wherein execution of the instructions by the at least one processor causes the at least one processor to: acquire a current ambient brightness; judge whether or not the brightness is less than a light compensation starting threshold, and if so, calculate a compensation brightness; and judge whether or not the compensation brightness is less than a brightness compensation extreme value of a screen, and if the compensation brightness is less than a brightness compensation extreme value of a screen, turn on the screen and adjust the brightness of the screen to the compensation brightness.

A further objective of the embodiments of the application is to provide a non-transitory computer-readable storage medium storing executable instructions that used for acquiring a current ambient brightness; judging whether or not the brightness is less than a light compensation starting threshold, and if so, calculating a compensation brightness; and judging whether or not the compensation brightness is less than a brightness compensation extreme value of a screen, and if the compensation brightness is less than a brightness compensation extreme value of a screen, turning on the screen and adjusting the brightness of the screen to the compensation brightness.

The embodiment of the application provides a brightness compensation method and an electronic device for a front camera, and a mobile terminal. The method includes: firstly, acquiring a current ambient brightness; then judging whether or not the brightness is less than a light compensation starting threshold, and if so, calculating a compensation brightness; and judging whether or not the compensation brightness is less than a brightness compensation extreme value of a screen, and if so, turning on the screen and adjusting the brightness of the screen to the compensation brightness. In the method, the screen is used for brightness compensation, and when the screen satisfies the requirement of brightness compensation, the screen is preferably used for compensation, thereby reducing the number of times of turning on a front flash, etc., prolonging the service life of the front flash, as well as satisfying a photo shooting requirement and obtaining a better selfie effect.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a brightness compensation method for a front camera in embodiment 1 of the application;

FIG. 2 is a structural block diagram of a mobile phone having a front camera brightness compensation function in embodiment 2 of the application;

FIG. 3 is a structural block diagram of a brightness compensation device for a front camera in embodiment 3 of the application;

FIG. 4 is a schematic diagram of hardware configuration of an electronic device performing a brightness compensation method for a front camera provided by the embodiment of the application.

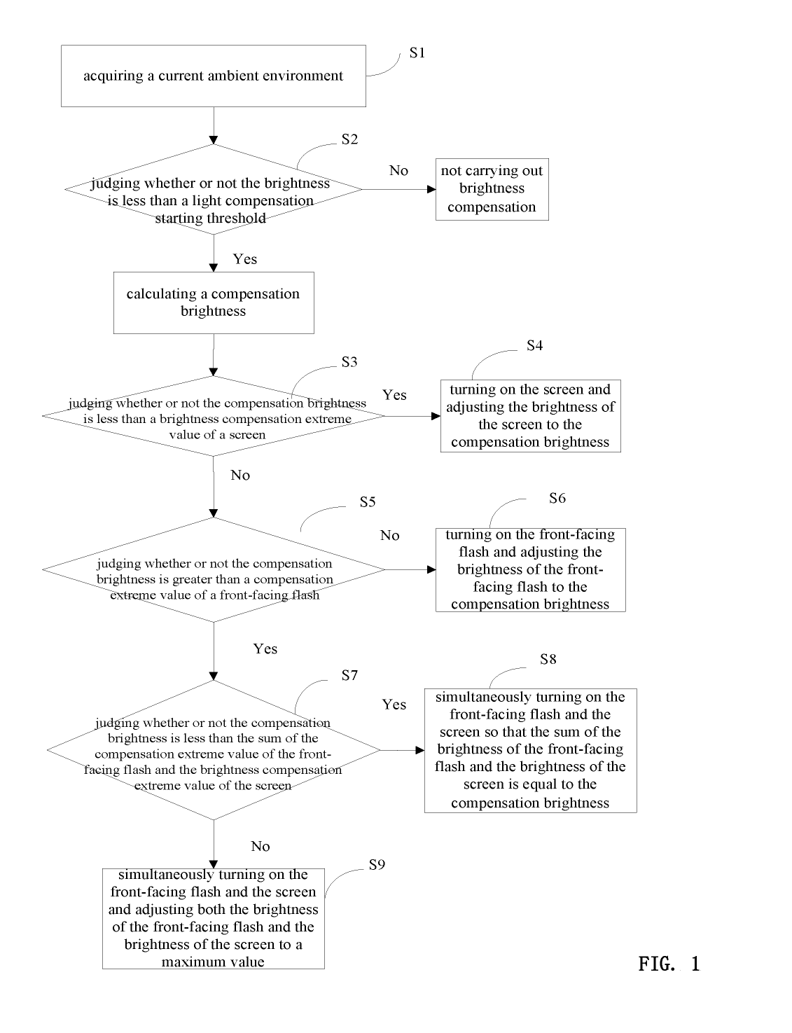

### DETAILED DESCRIPTION

In order to clearly describe objectives, the technical solutions and advantages of the application. A clear and complete description of the technical solutions in the application will be given below, in conjunction with the accompanying drawings in the embodiments of the application. Apparently, the embodiments described below are a part, but not all, of the embodiments of the application.

### Embodiment 1

The embodiment provides a brightness compensation method for a front camera. The method can be used for such mobile terminals as mobile phones, ipads, etc., and is used for performing brightness compensation on the front camera during shooting or video recording. The method includes the following steps:

S1, acquiring a current ambient brightness, wherein the current ambient brightness can be obtained by means of a built-in photosensor and other devices during shooting, so as to obtain the current ambient brightness;

S2, judging whether or not the brightness is less than a light compensation starting threshold, and if so, calculating a compensation brightness; and if not, which means light compensation is not needed, directly performing shooting; wherein after the current ambient brightness is obtained, according to the brightness requirement of a selected shooting mode, light compensation has a threshold; when the brightness is greater than the threshold, brightness compensation is not needed and photo shooting can be performed directly, but when the brightness is less than the threshold, compensation is needed; therefore, whether or not the current ambient brightness is less than the light compensation starting threshold needs to be judged first, and if so, the compensation brightness is calculated by subtracting the current ambient brightness from the brightness needed by shooting; and the brightness needed by shooting is different according to different shooting modes and is set in advance;

S3, judging whether or not the compensation brightness is less than a brightness compensation extreme value of a screen; wherein at this moment, the screen is preferably considered for compensation; when the screen can satisfy the compensation brightness, the screen is used; and when the compensation brightness is less than the brightness compensation extreme value of the screen, S4 is executed; or else, S5 is executed;

S4, turning on the screen and adjusting the brightness of the screen to the compensation brightness when the compensation brightness is less than the brightness compensation extreme value of the screen; wherein in the solution, the screen is used for brightness compensation; when the screen satisfies the requirement of brightness compensation, the screen is preferably used for compensation, thereby reducing the number of times of turning on the front flash, etc., prolonging the service life of the front flash, as well as satisfying a photo shooting requirement and obtaining a better self-shooting effect;

S5, in a further implementation solution, judging whether or not the compensation brightness is greater than a compensation extreme value of a front flash when the compensation brightness is not less than the brightness compensation extreme value of the screen and the requirement cannot be satisfied through screen compensation; if not, executing step S6; and if so, executing step S7;

S6, turning on the front flash and adjusting the brightness of the front flash to the compensation brightness when the compensation brightness is not greater than the compensation extreme value of the front flash; wherein if the screen cannot satisfy the requirement of brightness compensation while the flash can meet the compensation requirement, the front flash is used for light compensation and the brightness of the front flash is adjusted to reach the required compensation brightness; for example, the size of current in the front flash is controlled to make the front flash reach the required brightness, so that the current shooting requirement can be better satisfied and more energy can be saved as compared with the situation of using a front flash with unchanged brightness;

S7, judging whether or not the compensation brightness is less than the sum of the compensation extreme value of the front flash and the brightness compensation extreme value of the screen when the compensation brightness is greater than the compensation extreme value of the front flash; if so, executing step S8; and if not, executing S9;

S8, simultaneously turning on the front flash and the screen so that the sum of the brightness of the front flash and the brightness of the screen is equal to the compensation brightness; wherein at this moment, the brightness of the front flash is adjusted to the maximum value and the brightness of the screen is adjusted to a difference between the maximum value and the compensation brightness; optionally, the brightness of the screen can be adjusted to the maximum value and the brightness of the front flash is adjusted to a difference between the maximum value and the compensation brightness; of course, optionally, both the brightness of the front flash and the brightness of the screen can be not adjusted to the maximum value, while the same brightness percentage a is outputted; for example: (A+B)*a=M, wherein A is the brightness compensation extreme value of the screen, B is the compensation extreme value of the flash, a is the compensation percentage and M is the compensation brightness, and at this moment, the brightness of the front flash is adjusted to B*a and the brightness of the screen is adjusted to A*a;

S9, simultaneously turning on the front flash and the screen and adjusting both the brightness of the flash and the brightness of the screen to a maximum value, wherein when the requirement of brightness compensation cannot be satisfied by individually using the screen or the front flash, the screen and the front flash can be used together so as to satisfy the requirement of compensation, and the current brightness can be maximally compensated, thereby achieving a better shooting effect under adverse shooting conditions;

As a preferred solution, display colors of the screen are adjusted according to the ambient color when the screen is turned on, so that the ambient color can be better combined during brightness compensation, a compensation effect is better and better integration of background brightness and the colors during shooting is achieved. The screen can also be set as different colors according to the selection of the shooting mode herein, so that the shooting effect and the shooting mode match better.

### Embodiment 2

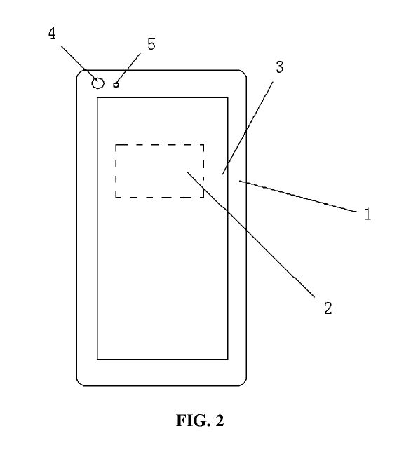

The embodiment provides a mobile terminal having a front camera brightness compensation function. The mobile terminal may be a mobile phone, a tablet personal computer, an ipad, etc., and the mobile terminal in the embodiment is the mobile phone. As shown in FIG. 2, the mobile terminal includes a face shell 1 and a rear shell which are in snap-fit arrangement, wherein a mobile phone controller 2 is arranged in a cavity formed by the face shell 1 and the rear shell; a screen 3 and a front camera 4 are arranged on the face shell 1; at least one front flash 5 is also arranged on the face shell 1; the brightness of the front flash 5 can be adjusted; and the mobile phone controller 2 is used for executing the brightness compensation electronic device for the front camera in embodiment 1 to control the brightness of the front flash 5 and the brightness of the screen 3.

As a preferred solution, a plurality of front flashes 5 may be arranged, and may also be located as needed, e.g., located beside the front camera 4 or located above, below or in the middle of the screen 3. During concrete implementation, the positions of the front flashes 5 can be selected as needed.

The mobile terminal can perform brightness compensation by adjusting the brightness of the screen 3 and the brightness of the front flashes 5 when the front camera 4 is used for shooting, thereby enhancing the shooting effect.

### Embodiment 3

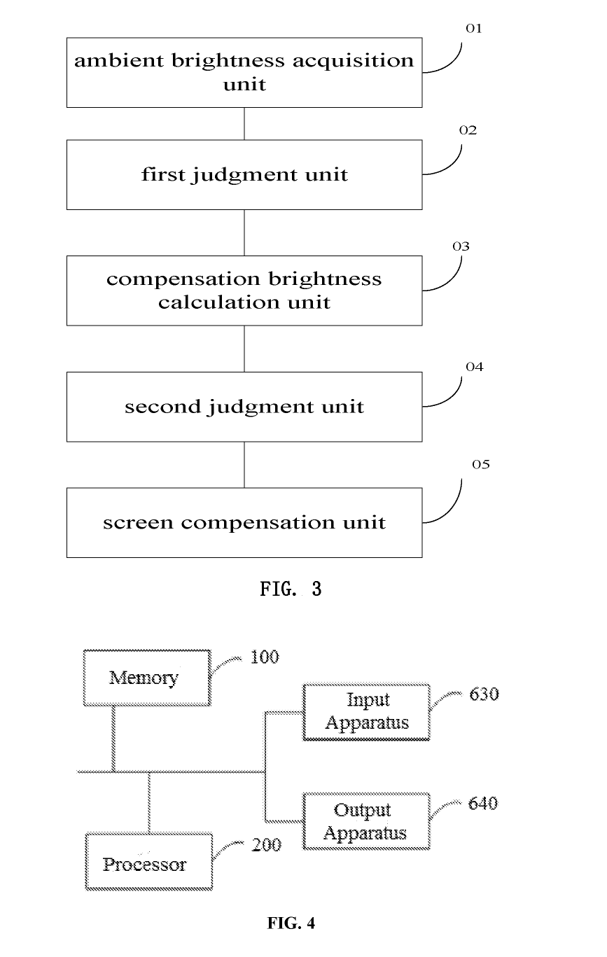

The embodiment provides a brightness compensation device for a front camera, referring to FIG. 3, including a brightness acquiring unit 01, for acquiring a current ambient brightness; a first judging unit 02, for judging whether or not the brightness is less than a light compensation starting threshold; a compensation brightness calculating unit 03, for and the brightness is less than a light compensation starting threshold, calculating a compensation brightness; a second judging unit 04, for judging whether or not the compensation brightness is less than a brightness compensation extreme value of a screen; a screen compensation unit 05, for turning on the screen and adjusting the brightness of the screen to the compensation brightness if the compensation brightness is less than a brightness compensation extreme value of a screen.

As a preferred embodiment, the device further includes a third judging unit, for judging whether or not the compensation brightness is greater than a compensation extreme value of a front flash when the compensation brightness is not less than the brightness compensation extreme value of the screen; a front flash compensation unit, for turning on the front flash and adjusting the brightness of the front flash to the compensation brightness if the compensation brightness is not less than the brightness compensation extreme value of the screen; a fourth judging unit, for judging whether or not the compensation brightness is less than the sum of the compensation extreme value of the front flash and the brightness compensation extreme value of the screen when the compensation brightness is greater than the compensation extreme value of the front flash; and a comprehensive compensation unit, for simultaneously turning on the front flash and the screen to allow the sum of the brightness of the front flash and the brightness of the screen is equal to the compensation brightness, if the compensation brightness is less than the sum of the compensation extreme value of the front flash and the brightness compensation extreme value of the screen; an extreme compensation unit, for turning on the front flash and the screen are simultaneously and adjusting both the brightness of the flash and the brightness of the screen to a maximum value when the compensation brightness is not less than the sum of the compensation extreme value of the front flash and the brightness compensation extreme value of the screen.

As a preferred embodiment, the device further includes a color adjusting unit for adjusting display colors of the screen according to the ambient color when the screen is turned on.

In the brightness compensation device for a front camera of this embodiment, the brightness compensation is conducted by adjusting the brightness of the screen and front flash, so as to improve the quality of photographing, which may be applied to self photographing or video call, etc.

### Embodiment 4

The embodiment of the application provides a non-transitory computer-readable storage medium storing executable instructions that are capable of performing the brightness compensation method for a front camera of any one of the above-mentioned method embodiments.

### Embodiment 5

FIG. 4 is a schematic diagram of the hardware configuration of the electronic device provided by the embodiment of the application, which performs the brightness compensation method for a front camera. As shown in FIG. 4, the electronic device includes: one or more processors 200 and a memory 100, wherein one processor 200 is shown in FIG. 4 as an example. The electronic device that performs the brightness compensation method for a front camera further includes an input apparatus 630 and an output apparatus 640.

The processor 200, the memory 100, the input apparatus 630 and the output apparatus 640 may be connected via a bus line or other means, wherein connection via a bus line is shown in FIG. 4 as an example.

The memory 100 is a non-transitory computer-readable storage medium that can be used to store non-transitory software programs, non-transitory computer-executable programs and modules, such as the program instructions/modules corresponding to the brightness compensation method for a front camera (e.g. ambient brightness acquisition unit 01, first judgment unit 02, compensation brightness calculation unit, the recognition unit 03, second judgment unit 04 and screen compensation unit 05 shown in the FIG. 3). The processor 200 executes the non-transitory software programs, instructions and modules stored in the memory 100 so as to perform various function application and data processing of the server, thereby implementing the brightness compensation method for a front camera of the above-mentioned method embodiments

The memory 100 includes a program storage area and a data storage area, wherein the program storage area can store an operation system and application programs required for at least one function; the data storage area can store data generated by use of the brightness compensation device for a front camera. Furthermore, the memory 100 may include a high-speed random access memory, and may also include a non-volatile memory, e.g. at least one magnetic disk memory unit, flash memory unit, or other non-volatile solid-state memory unit. In some embodiments, optionally, the memory 100 includes a remote memory accessed by the processor 200, and the remote memory is connected to the brightness compensation device for a front camera via network connection. Examples of the aforementioned network include but not limited to internet, intranet, LAN, GSM, and their combinations.

The input apparatus 630 receives digit or character information, so as to generate signal input related to the user configuration and function control of the brightness compensation device for a front camera. The output apparatus 640 includes display devices such as a display screen.

The one or more modules are stored in the memory 100 and, when executed by the one or more processors 200, perform the brightness compensation method for a front camera of any one of the above-mentioned method embodiments.

The above-mentioned product can perform the method provided by the embodiments of the application and have function modules as well as beneficial effects corresponding to the method. Those technical details not described in this embodiment can be known by referring to the method provided by the embodiments of the application.

The electronic device of the embodiments of the application can exist in many forms, including but not limited to:

(1) Mobile communication devices: The characteristic of this type of device is having a mobile communication function with a main goal of enabling voice and data communication. This type of terminal device includes: smartphones (such as iPhone), multimedia phones, feature phones, and low-end phones.

(2) Ultra-mobile personal computer devices: This type of device belongs to the category of personal computers that have computing and processing functions and usually also have mobile internet access features. This type of terminal device includes: PDA, MID, UMPC devices, such as iPad.

(3) Portable entertainment devices: This type of device is able to display and play multimedia contents. This type of terminal device includes: audio and video players (such as iPod), handheld game players, electronic books, intelligent toys, and portable GPS devices.

(4) Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

(5) Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the application, without restricting the technical scheme of the application. Although detailed description of the application is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the application.

1. A brightness compensation method for a front camera, wherein comprising the following steps:
acquiring a current ambient brightness;
judging whether or not the brightness is less than a light compensation starting threshold, and if so, calculating a compensation brightness; and
judging whether or not the compensation brightness is less than a brightness compensation extreme value of a screen, and if the compensation brightness is less than a brightness compensation extreme value of a screen, turning on the screen and adjusting the brightness of the screen to the compensation brightness.

2. The method according to claim 1, wherein whether or not the compensation brightness is greater than a compensation extreme value of a front flash is judged when the compensation brightness is not less than the brightness compensation extreme value of the screen, and if not, the front flash is turned on and the brightness of the front flash is adjusted to the compensation brightness.

3. The method according to claim 2, wherein whether or not the compensation brightness is less than the sum of the compensation extreme value of the front flash and the brightness compensation extreme value of the screen is judged when the compensation brightness is greater than the compensation extreme value of the front flash, and if so, the front flash and the screen are simultaneously turned on so that the sum of the brightness of the front flash and the brightness of the screen is equal to the compensation brightness.

4. The method according to claim 3, wherein the front flash and the screen are simultaneously turned on and the brightness of the flash and the brightness of the screen are both adjusted to a maximum value when the compensation brightness is not less than the sum of the compensation extreme value of the front flash and the brightness compensation extreme value of the screen.

5. The method according to claim 3, wherein in the step of simultaneously turning on the front flash and the screen so that the sum of the brightness of the front flash and the brightness of the screen is equal to the compensation brightness, the brightness of the front flash is adjusted to the maximum value and the brightness of the screen is adjusted to a difference between the maximum value and the compensation brightness.

6. The method according to claim 1, wherein further comprising adjusting display colors of the screen according to the ambient color when the screen is turned on.

7. The electronic device according to claim 9, wherein the electronic device is implemented as part of a mobile terminal having a front camera brightness compensation function, wherein the mobile terminal comprises a face shell and a rear shell which are in snap-fit arrangement, wherein the at least one processor and the memory are arranged in a cavity formed by the face shell and the rear shell, and the screen and a front camera are arranged on the face shell; and wherein at least one front flash is also arranged on the face shell, the brightness of the front flash can be adjusted, and the at least one processor is used to control the brightness of the front flash and the brightness of the screen.

8. The electronic device of claim 7, wherein the mobile terminal comprises a plurality of front flashes.

9. An electronic device, comprising:
at least one processor; and
a memory communicably connected with the at least one processor for storing instructions executable by the at least one processor, wherein execution of the instructions by the at least one processor causes the at least one processor to:
acquire a current ambient brightness;
judge whether or not the brightness is less than a light compensation starting threshold, and if so, calculating a compensation brightness; and
judge whether or not the compensation brightness is less than a brightness compensation extreme value of a screen, and if the compensation brightness is less than the brightness compensation extreme value of the screen, turn on the screen and adjust the brightness of the screen to the compensation brightness.

10. The electronic device of claim 9, wherein whether or not the compensation brightness is greater than a compensation extreme value of a front flash is judged when the compensation brightness is not less than the brightness compensation extreme value of the screen, and if not, the front flash is turned on and the brightness of the front flash is adjusted to the compensation brightness.

11. The electronic device of claim 10, wherein whether or not the compensation brightness is less than the sum of the compensation extreme value of the front flash and the brightness compensation extreme value of the screen is judged when the compensation brightness is greater than the compensation extreme value of the front flash, and if so, the front flash and the screen are simultaneously turned on so that the sum of the brightness of the front flash and the brightness of the screen is equal to the compensation brightness.

12. The electronic device of claim 11, wherein whether or not the compensation brightness is greater than a compensation extreme value of a front flash is judged when the compensation brightness is not less than the brightness compensation extreme value of the screen, and if not, the front flash is turned on and the brightness of the front flash is adjusted to the compensation brightness.

13. The electronic device of claim 12, wherein the front flash and the screen are simultaneously turned on and the brightness of the flash and the brightness of the screen are both adjusted to a maximum value when the compensation brightness is not less than the sum of the compensation extreme value of the front flash and the brightness compensation extreme value of the screen.

14. A non-transitory computer-readable storage medium storing executable instructions that are used to:
acquire a current ambient brightness;
judge whether or not the brightness is less than a light compensation starting threshold, and if so, calculate a compensation brightness; and
judge whether or not the compensation brightness is less than a brightness compensation extreme value of a screen, and if the compensation brightness is less than a brightness compensation extreme value of a screen, turn on the screen and adjust the brightness of the screen to the compensation brightness.

15. The non-transitory computer-readable storage medium according to claim 14, wherein whether or not the compensation brightness is greater than a compensation extreme value of a front flash is judged when the compensation brightness is not less than the brightness compensation extreme value of the screen, and if not, the front flash is turned on and the brightness of the front flash is adjusted to the compensation brightness.

16. The non-transitory computer-readable storage medium according to claim 15, wherein whether or not the compensation brightness is less than the sum of the compensation extreme value of the front flash and the brightness compensation extreme value of the screen is judged when the compensation brightness is greater than the compensation extreme value of the front flash, and if so, the front flash and the screen are simultaneously turned on so that the sum of the brightness of the front flash and the brightness of the screen is equal to the compensation brightness.

17. The non-transitory computer-readable storage medium according to claim 16, wherein the front flash and the screen are simultaneously turned on and the brightness of the flash and the brightness of the screen are both adjusted to a maximum value when the compensation brightness is not less than the sum of the compensation extreme value of the front flash and the brightness compensation extreme value of the screen.

18. The non-transitory computer-readable storage medium according to claim 17, wherein the front flash and the screen are simultaneously turned on so that the sum of the brightness of the front flash and the brightness of the screen is equal to the compensation brightness, the brightness of the front flash is adjusted to the maximum value and the brightness of the screen is adjusted to a difference between the maximum value and the compensation brightness.

19. The non-transitory computer-readable storage medium according to claim 14, wherein the executable instructions are also used to display colors of the screen are adjusted according to the ambient color when the screen is turned on.
